(19) United States
(12) Patent Application Publication
(10) Pub. No.: US 2019/0080496 A1
(43) Pub. Date: Mar. 14, 2019

(54) VEHICLE DISPLAY DEVICE AND DISPLAY CONTROL METHOD

(71) Applicant: Yazaki Corporation, Tokyo (JP)

(72) Inventors: Tomotake WAKATSUKI, Shizuoka (JP); Kazuyoshi OGASAWARA, Shizuoka (JP)

(73) Assignee: Yazaki Corporation, Tokyo (JP)

(21) Appl. No.: 16/125,850

(22) Filed: Sep. 10, 2018

(30) Foreign Application Priority Data
Sep. 12, 2017 (JP) 2017-174606

(51) Int. Cl. G06T 11/60; G02B 27/01; B60R 1/00

(52) U.S. Cl. CPC G06T 11/60; G06T 7/70; B60R 1/00; G02B 27/0101

(57) ABSTRACT

A vehicle display device includes a vehicle front side camera that acquires a plurality of front area images by sequentially capturing a real landscape in front of a vehicle chronologically, an image analyzing unit that detects a position of a white line extending from an own vehicle side to an area in front of the vehicle in each of the front area images, and a controller that acquires an information image to be informed to the driver. The controller causes the information image to he displayed superimposed on the real landscape in a shape based on a shape of the white line in the real landscape obtained from a position of the white line.

### CROSS-REFERENCE TO RELATED APPLICATION(S)

The present application claims priority to and incorporates by reference the entire contents of Japanese Patent Application No. 2017-174606 filed in Japan on Sep. 12, 2017.

### BACKGROUND OF THE INVENTION

### 1. Field of the invention

The present invention relates to a vehicle display device and a display control method.

### 2. Description of the Related Art

Conventionally, head-up display devices which are installed in vehicles such as automobiles and project a display image from a display device onto a windshield and cause a driver to visually recognize the display image superimposed on a real landscape have been provided. For example, a navigation device that decides a priority of an obstacle or the like which is not to be overlooked by the driver when guidance information is displayed superimposed on a real landscape, and decides a display position and a display method of the guidance information so that conspicuousness of an obstacle with a higher priority than the guidance information is not remarkably lowered is disclosed in Japanese Patent Application Laid-open No. 2006-162442.

However, in the technique disclosed in Japanese Patent Application Laid-open No. 2006-162442, since the display position and the display method of the guidance information are changed while the vehicle is traveling, it is necessary for the driver to search for the guidance information displayed on the windshield, and there is room for improvement.

### SUMMARY OF THE INVENTION

It is an object of the present invention to provide a vehicle display device and a display control method which are capable of displaying information to be informed to the driver on a road at which the driver is constantly looking.

A vehicle display device according to one aspect of the present invention projects a display image in front of a driver of a vehicle and causes the display image to be displayed superimposed on a real landscape in front of the vehicle, and the vehicle display device includes a front area image acquiring unit that acquires a plurality of front area images by sequentially capturing the real landscape in front of the vehicle chronologically; a colored line detecting unit that detects a position of at least one colored line extending from an own vehicle side to an area in front of the vehicle in each of the front area images; and a controller that acquires an information image to be informed to the driver, wherein the controller causes the information image to be displayed superimposed on the real landscape in a shape based on a shape of the colored line in the real landscape obtained from a position of the colored line, and causes a shape of the information image to be changed to a shape based on a change in the shape of the colored line in the real landscape chronologically obtained from the position of the colored line.

According to another aspect of the present invention, in the vehicle display device, it is preferable that the information image includes an image relating to route guidance of the vehicle.

According to still another aspect of the present invention, in the vehicle display device, it is preferable that the colored line detecting unit detects positions of a pair of colored lines sandwiching a lane extending from its own vehicle side to the area in front of the vehicle, in a case in which an image relating to route guidance of the vehicle in the information image to be displayed is a left turn or a lane change to a left side of the own vehicle, the controller causes the information image to be displayed along a position of a left side colored line in the real landscape in a shape based on a shape of the left side colored line sandwiching the lane out of the pair of colored lines, and in a case in which the image relating to the route guidance of the vehicle in the information image to be displayed is a right turn or a lane change to a right side of the own vehicle, the controller causes the information image to be displayed along a position of a right side colored line in the real landscape in a shape based on a shape of the right side colored line sandwiching the lane out of the pair of colored lines.

In a display control method according to still another aspect of the present invention, a vehicle display device projects a display image in front of a driver of a vehicle and causes the display image to be displayed superimposed on a real landscape in front of the vehicle, and the display control method includes a front area image acquisition step of acquiring a plurality of front area images by sequentially capturing the real landscape in front of the vehicle chronologically; a colored line detection step of detecting a position of at least one colored line extending from an own vehicle side to an area in front of the vehicle in each of the front area images; an image display step of causing an information image to be informed to the driver to be displayed superimposed on the real landscape in a shape based on a shape of the colored line in the real landscape obtained from a position of the colored line; and a control step of causing a shape of the information image to be changed to a shape based on a change in the shape of the colored line in the real landscape chronologically obtained from the position of the colored line.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicle display device according to a first embodiment;

FIG. 2 is a block diagram of the vehicle display device according to the first embodiment;

FIG. 3 is a flowchart illustrating an operation example of the vehicle display device according to the first embodiment;

FIG. 4 is an explanatory diagram for describing white line detection of a front area image according to the first embodiment;

FIGS. 5A and 5B are explanatory diagrams for describing white line detection of a front area image according to the first embodiment;

FIG. 6 is an explanatory diagram of white line detection and preceding vehicle detection of a front area image according to the first embodiment;

FIG. 7 is a diagram illustrating an example of an information image according to the first embodiment;

FIG. 8 is a diagram illustrating an example of an information image according to the first embodiment;

FIG. 9 is a diagram illustrating an example of an information image according to a second embodiment;

FIG. 10 is a diagram illustrating another example of an information image according to the second embodiment;

FIG. 11 is a diagram illustrating an example of an information image according to a third embodiment;

FIGS. 12A to 12C are diagrams for describing a change in an information image according to a fourth embodiment; and

FIGS. 13A to 13C are diagrams for describing a change in an information image according to the fourth embodiment.

### DETAILED DESCRIPTION OF THE PREFERRED EMBODIMENTS

Hereinafter, exemplary embodiments of a vehicle display device and a display control method according to the present invention will be described in detail with reference to the appended drawings. The present embodiment not limited by the following embodiments. In addition, constituent elements in the following embodiments include those which can be easily replaced by those skilled in the art or are substantially the same. Further, various omissions, substitutions, and changes can be made to the constituent elements in the following embodiments within the scope not deviating from the gist of the invention.

### First Embodiment

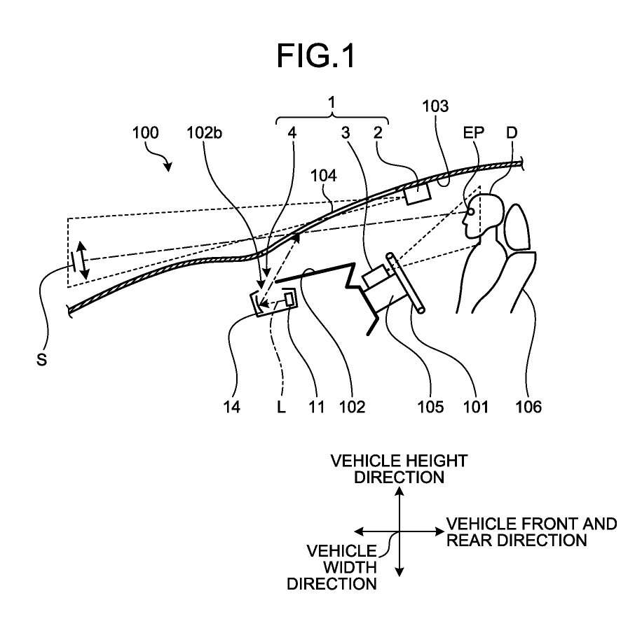

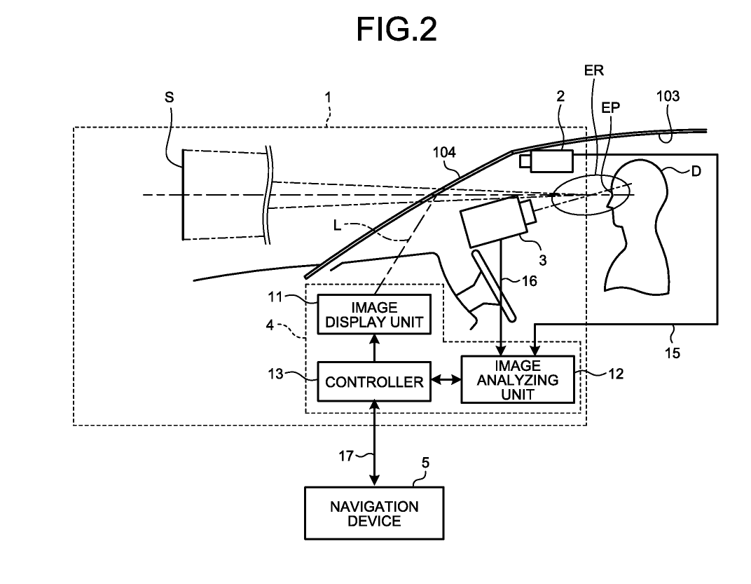

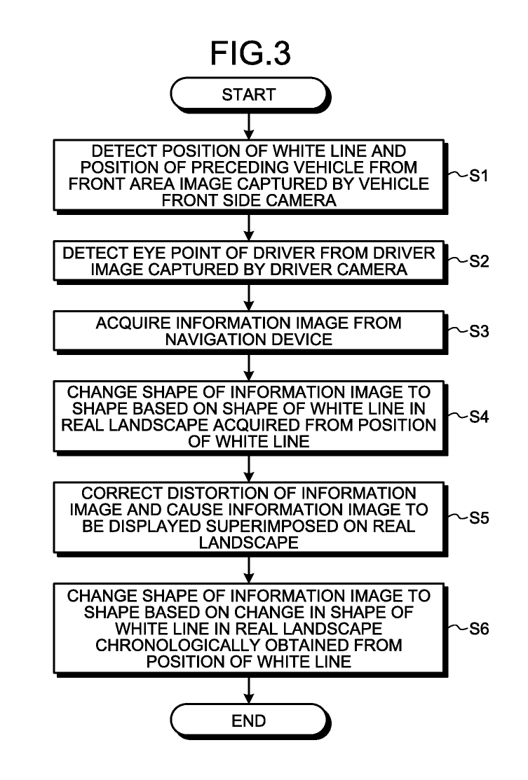

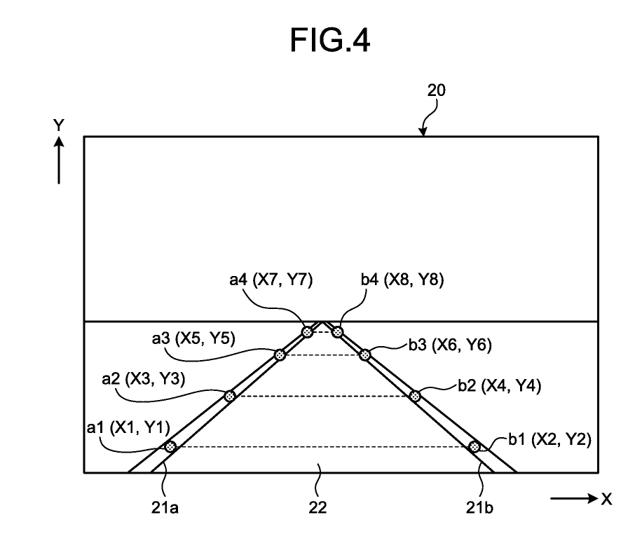

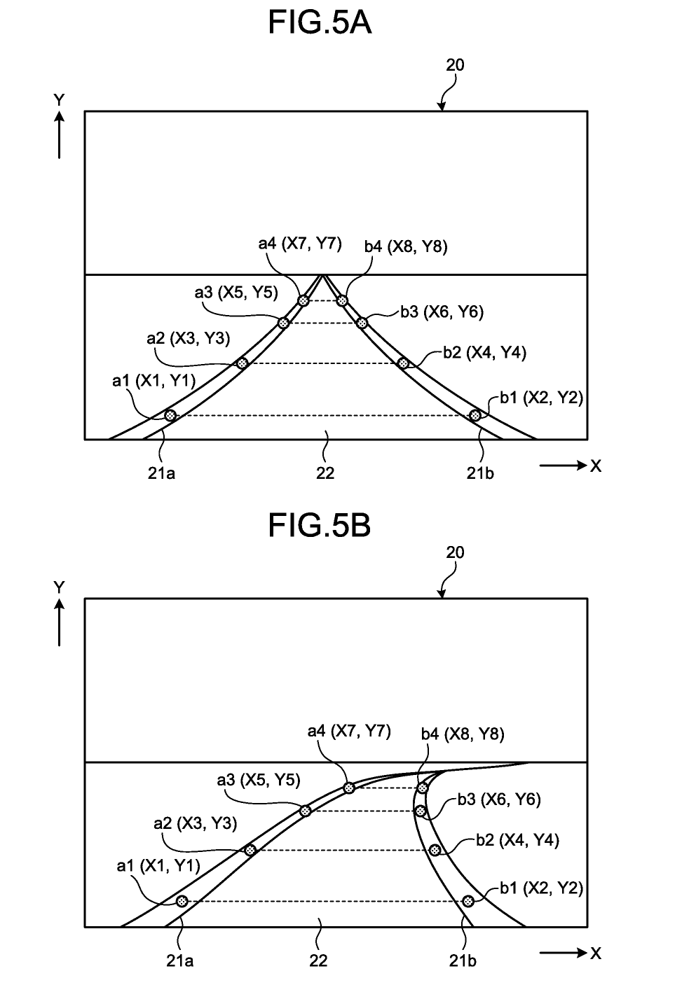

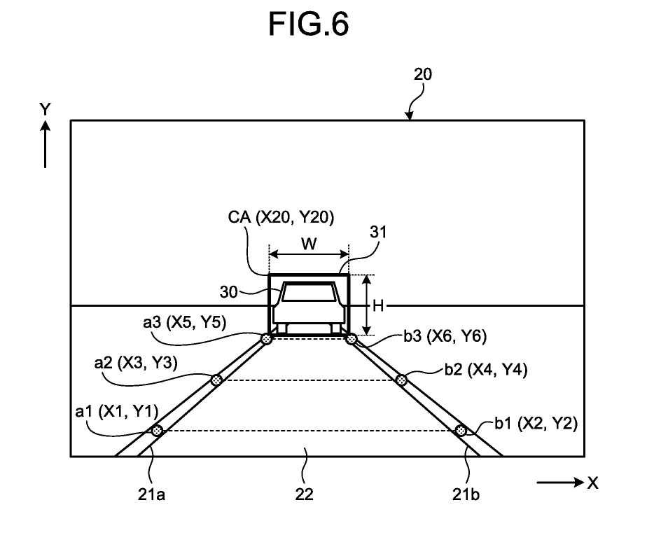

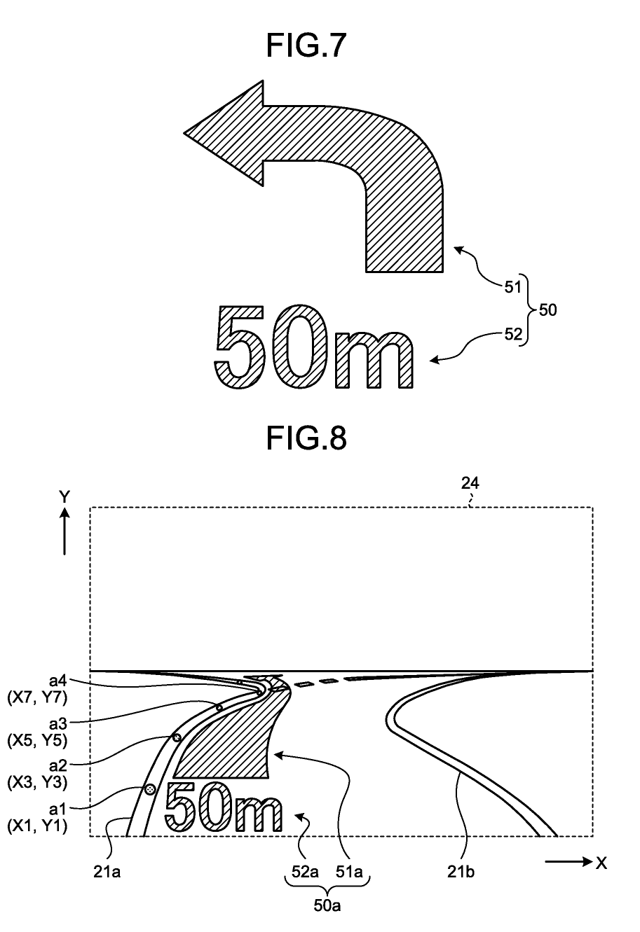

FIG. 1 is a schematic configuration diagram of a vehicle display device according to a first embodiment. FIG. 2 is a block diagram of the vehicle display device according to the first embodiment. FIG. 3 is a flowchart illustrating an operation example of the vehicle display device according to the first embodiment. FIG. 4 is an explanatory diagram for describing white line detection of a front area image according to the first embodiment. FIGS. 5A and 5B are explanatory diagrams for describing white line detection of a front area image according to the first embodiment. FIG. 6 is an explanatory diagram for describing white line detection and preceding vehicle detection of a front area image according to the first embodiment. FIG. 7 is a diagram illustrating an example of an information image according to the first embodiment. FIG. 8 is a diagram illustrating an example of an information image according to the first embodiment. The front area image illustrated in FIG. 4 is an image captured on a flat road. The front area image illustrated in FIG. 5A is an image captured on a sloping road, and the front area image illustrated on FIG. 5B is an image captured on a road bent in a curved shape to the right. FIG. 8 illustrates an example of an information image which is projected onto a display range on a windshield and superimposed on a real landscape.

As illustrated in. FIGS. 1 and 2, a vehicle display device 1 according to the first embodiment is, for example, a head up display (HUD) device installed in a vehicle 100 such as automobile. The vehicle display device 1 projects a display image onto a windshield 104 of the vehicle 100 and displays the display image superimposed on the real landscape in front of the vehicle. The windshield 104 has semi-transparency and reflects laser light L incident from the vehicle display device 1 toward an eye point EP. The eye point EP is a viewpoint position of a driver D sitting on a driving seat 106 of the vehicle 100. The eye point EP indicates, for example, a part between the eyes of the driver D (between the eyebrows). The eye point EP is preset to be located in a so-called ear range ER in the vehicle 100. Here, the ear range ER is a “driver ear range of an automobile” and corresponds to an area in which a predetermined viewpoint of the driver D is positioned in accordance with the vehicle 100. The ear range ER is a statistical representation of a distribution of the positions of the eyes of the driver D in the vehicle 100 and corresponds to, for example, a region in which the positions of the eyes of a predetermined percentage (for example, 95%) of the driver D are included in a state in which the driver D is sitting on the driving seat 106. The driver D recognizes an image reflected by the windshield 104 as a virtual image S. The driver D recognizes a display image reflected the windshield 104 as the virtual image S. The driver D recognizes the virtual image S as if the virtual image S is positioned in front of the windshield 104. The display image is, for example, an information image 50a illustrated in FIG. 8 and projected onto a display range 24 on the windshield 104. The information image 50a is, for example, route guidance information to be informed to the driver D. The route guidance information includes a right/left turning direction or a course change destination of the vehicle 100 which is an own vehicle, a distance to an intersection, a landmark, lane information, and the like. The information image 50a is an image in which an information image 50 illustrated in FIG. 7 is superimposed on the real landscape in a shape based on a shape of a white line on the road. The information image 50 is obtained from a navigation device 5 to be described later and is an original image of the information image 50a. The information images 50 and 50a include arrow images 51 and 51a indicating a right or left turn or a lane change destination and distance images 52 and 52a indicating a distance to a corresponding spot, respectively, but the present embodiment is not limited thereto. Specifically, the vehicle display device 1 includes a vehicle front side camera 2, a driver camera 3, and a vehicle display device main body 4.

The vehicle front side camera 2 is a front area image acquiring unit, and acquires a plurality of front area images 20 (see FIG. 4 or the like) by capturing the real landscape ahead of its own vehicle continuously chronologically. The vehicle front side camera 2 is arranged in a passenger compartment of the vehicle 100. The vehicle front side camera 2 is arranged, for example, in a roof 103 in the passenger compartment of the vehicle 100. The vehicle front side camera 2 may be installed on a rearview mirror (not illustrated) arranged on the roof 103. The vehicle front side camera 2 is installed to capture an area in front of the vehicle 100 through the windshield 104. The imaging range by the vehicle front side camera 2 is set to be able capture the white line on the road or a preceding vehicle 30 (see FIG. 6) traveling in front of its own vehicle. The vehicle front side camera 2 is connected to the vehicle display device main body via a communication line 15. The vehicle front side camera 2 sequentially outputs the captured images to the vehicle display device main body 4 as the front area image 20 via the communication line 15. The output image also includes a moving image.

The driver camera 3 sequentially captures the driver D and acquires a driver image. The driver camera 3 is arranged in front of the driver D in the compartment of the vehicle 100. The driver camera 3 is arranged, for example, on the top of a steering column 105 and behind a steering wheel 101 when viewed from the driver D. The driver camera 3 is installed to capture at least the eye point EP of the driver D. The imaging range by the driver camera 3 is decided so that at least the face part including both eyes of the driver D can be captured. The driver camera 3 is connected to the vehicle display device main body 4 via a communication line 16. The driver camera 3 sequentially outputs the captured images as to the vehicle display device main body 4 the driver image via the communication line 16. The output image also includes a moving image.

The vehicle display device main body 4 projects die display image by radiating the laser light L toward the windshield 104. The vehicle display device main body 4 is arranged inside an instrument panel 102 of the vehicle 100. An opening 102b is formed on the upper surface of the instrument panel 102. The vehicle display device main body 4 projects the display image by radiating the laser light L toward the windshield 104 through the opening 102b. As illustrated in FIG. 2, the vehicle display device main body 4 includes an image display unit 11, an image analyzing unit 12, and a controller 13.

The image display unit 11 projects the display image onto the windshield 104 on the basis of a control signal from the controller 13. The image display unit 11 is, for example, a liquid crystal display device such as a thin film transistor-liquid crystal display (TFT-LCD). The image display unit 11 includes a liquid crystal display unit (not illustrated) and a backlight (not illustrated). The liquid crystal display unit displays an arbitrary image, for example, a color image. The backlight radiates light from the back side of the liquid crystal display unit and projects the image displayed on the liquid crystal display unit toward a reflective mirror 14. The reflective mirror 14 reflects the image projected from the image display unit 11 toward the windshield 104. The image which is reflected and projected by the reflective mirror 14 is reflected toward the driver D by the windshield 104. The image reflected by the windshield 104 is formed as the virtual image S at a position in front of the windshield 104 when viewed from the driver D.

The image analyzing unit 12 is a colored line detecting unit. The image analyzing unit 12 is connected to the vehicle front side camera 2 via the communication line 15 and receives a plurality of front area images 20. On the basis of the control signal from the controller 13, the image analyzing unit 12 detects the positions of a pair of white lines 21a and 21b sandwiching a lane 22 therebetween extending forward from its own vehicle side from each front area image 20. The positions of the white lines 21a and 21b are indicated by, for example, coordinates on a plane set in the front area image 20. The lane 22 is a region sandwiched between a pair of white lines 21a and 21b extending to the front of the vehicle 100 in the front area image 20. Therefore, the lane 22 is specified by the positions of the white lines 21a and 21b. The image analyzing unit 12 detects the presence or absence of the preceding vehicle 30 on the lane 22 from each front area image 20 and detects the position of the preceding vehicle 30. The position of the preceding vehicle 30 is indicated by, for example, coordinates in the front area image 20, a height H of the preceding vehicle 30, and a width W of the preceding vehicle 30. The image analyzing unit 12 may be configured to detect the position of the preceding vehicle 30 using an advanced driver assistance system.

The image analyzing unit 12 is connected to the driver camera 3 via the communication line 16 and receives a plurality of driver images. On the basis of the control signal from the controller 13, the image analyzing unit 12 detects the position of the eye point EP of the driver D from each driver image. The position of the eye point EP is indicated by, for example, three-dimensional orthogonal coordinates set in the vehicle 100. The coordinates indicating the position of the eye point EP may include the position in a vehicle width direction of the vehicle 100 and the position in a vehicle height direction and may further include the position in a vehicle longitudinal direction. The image analyzing unit 12 detects the position of the eye point EP, but the controller 13 may detect the position of the eye point EP.

The controller 13 is connected to the navigation device 5 and acquires the information image 50. The controller 13 is connected to the image analyzing unit 12 and acquires the positions of a pair of white lines 21a and 21b or the positions of a pair of white lines 21a and 21b and the position of the preceding vehicle 30 and acquires the position of the eye point EP. The controller 13 is connected to the image display unit 11 and outputs the display image to be projected onto the windshield 104. The controller 13 according to the present embodiment causes the acquired information image 50 to have a shape based on the shape of the white line in the real landscape obtained from the positions of a pair of white lines 21a and 21b. For example, as illustrated in FIG. 8, the controller 13 changes the information image 50 to the information image 50a having a shape based on the shape of the white line 21a. For example, the shape of the white line 21a is obtained from a plurality of coordinates a1 (X1, Y1), a2 (X3, Y3), a3 (X5, Y5), and a4 (X7, Y7) or the like indicating the position of the white line 21a. The controller 13 outputs the information image 50a to the image display unit 11 and causes the information image 50a to be displayed superimposed on the real landscape by the image display unit 11 to display. The controller 13 finely adjusts the position of the information image 50a in accordance with the acquired position of the eye point P.

Further, the controller 13 causes the shape of the information image 50a to be changed to the shape based on a change in the shape of the white line in the real landscape chronologically obtained from the positions of a pair of white lines 21a and 21b. For example, the controller 13 causes the shape of the information image 50a to be changed in accordance with the change in the shape of the white line 21a in the real landscape. The change in the shape of the white line 21a is obtained from the change in the respective coordinates of the white line 21a. The controller 13 outputs the information image 50a changed in accordance with the change in the shape of the white line in the real landscape to the image display unit 11 and causes the information image 50a to be displayed superimposed on the real landscape by the image display unit 11.

In a case in which the arrow image 51 in the acquired information image 50 is a left turn of its own vehicle or a lane change to the left side, the controller 13 causes the arrow image 51 to be displayed along the position of the left white line 21a sandwiching the lane 22 out of a pair of white lines 21a and 21b. On the other hand, in a case in which the arrow image 51 is a right turn of its own vehicle or a lane change to the right side, the controller 13 causes the arrow image 51 to be displayed along the position of the right white line 21b sandwiching the lane 22 out of a pair of white lines 21a and 21b. Further, in a case in which the arrow image 51 is an arrow indicating going straight forward, the controller 13 sets an area on the lane 22 on the basis of the positions of a pair of white lines 21a and 21b or the positions of a pair of white lines 21a and 21b and the position of the preceding vehicle 30 and causes the information image 50a to be displayed in the area. The information image 50a preferably has a shape based on a shape of the area set on the lane 22. The controller 13 is, for example, a computer having a central processing unit (CPU), a memory, various kinds of interfaces, and the like and controls the vehicle front side camera 2, the driver camera 3, the image display unit 11, and the image analyzing unit 12. The controller 13 is communicably connected to the vehicle front side camera 2, the driver camera 3, the image display unit 11, and the navigation device 5. The controller 13 acquires route guidance information from the navigation device 5 and determines whether or not the route guidance information can be displayed. The controller 13 is configured separately from the image display unit 11 and the image analyzing unit 12, or the controller 13 may be configured integrally with the image display unit 11 and the image analyzing unit 12.

The navigation device 5 is a so-called car navigation system and is a device that provides the position of its own vehicle or detailed map information of surrounding areas to the passenger of the vehicle 100 including the driver D and gives route guidance to the destination. The navigation device 5 acquires the position of its own vehicle on the basis of information from global positioning system (GPS) satellites or the like. Further, the navigation device 5 reads the map information, the route guidance information, or the like from an internal memory or acquires the map information, the route guidance information, or the like from the outside through communication. The navigation device 5 is connected to the controller 13 via a communication line 17 and outputs the acquired position information of its own vehicle or various information to the controller 13 via the communication line 17. Next, an operation of the vehicle display device 1 according to the first embodiment will be described with reference to FIG. 3. The vehicle display device 1 is assumed to be started together with the start of the vehicle 100 (for example, when an ignition switch is turned on) and stopped with the stop of the vehicle 100 (for example, when the ignition switch is turned off), but the present embodiment is not limited thereto.

In FIG. 3, in Step S1, the image analyzing unit 12 acquires a plurality of front area images 20 captured by the vehicle front side camera 2, and performs white line detection and preceding vehicle detection on the basis of the respective front area images 20. The image analyzing unit 12, performs only the white line detection in a case in which the preceding vehicle 30 is not present on the lane 22, and the preceding vehicle 30 is unable to be detected. The image analyzing unit 12 acquires the coordinates indicating the positions of the white lines 21a and 21b in each front area image 20 through the white line detection. The coordinates indicating the position of the white line 21a (hereinafter also referred to as “coordinates of the white line 21a”) are indicated by, for example, a1 (X1, Y1), a2 (X3, Y3), a3 (X5, Y5), a4 (X7, Y7), and the like as illustrated in FIGS. 4, 5A and 5B. On the other hand, the coordinates indicating the position of the white line 21b (hereinafter also referred to as “coordinates of the white line 21b”) are indicated by b1 (X2, Y2) b2 (X4, Y4), b3 (X6, Y6), b4 (X8, Y8), and the like. In a case in which there is a preceding vehicle 30 on the lane 22, using the preceding vehicle detection, as illustrated in FIG. 6, the image analyzing unit 12 acquires coordinates CA (X20, Y20) indicating the position of the preceding vehicle 30, the height H of the preceding vehicle 30, and the width W of the preceding vehicle 30. The coordinates CA indicating the position of the preceding vehicle 30 (hereinafter also referred to as “coordinates of the preceding vehicle 30”) are coordinate of an upper left corner of a rectangular region 31 illustrated in FIG. 6, but the present embodiment is not limited thereto. The region 31 is specified by the coordinates CA, the height H, and the width W.

In Step S2, the image analyzing unit 12 acquires the driver image captured by the driver camera 3 and detects the eye point of the driver D from the driver image. The image analyzing unit 12 acquires the coordinates indicating the position of the eye point EP of the driver D through the eye point detection.

In Step S3, the controller 13 acquires the information image 50 from the navigation device 5, analyzes the information image 50, and determines the shapes of the arrow image 51 and the distance image 52. The controller 13 determines the right turn, the left turn, the lane change, or the like of its own vehicle on the basis of, for example, the shape of the arrow image 51.

In Step S4, the controller 13 changes the shape of the information image 50 to the shape based on the shape based on the shape of the white line in the real landscape obtained from the positions of the white lines 21a and 21b as illustrated in FIG. 8. The controller 13 recognizes the shape of the white line 21a from a plurality of coordinates indicating the position of one of the white lines 21a and 21b, for example, the white line 21a, and changes the information image 50 to the information image 50a having the shape based on the shape of the white line 21a. In a case in which the shape of the information image 50 is changed, it is preferable to cause the shape of the information image 50 to be changed so that the information image 50 can be recognized by the driver.

In Step S5, the controller 13 corrects a distortion of the information image 50a projected onto the windshield 104 and causes the information image 50a to be displayed superimposed on the real landscape by the image display unit 11. The controller 13 causes the information image 50a to be displayed superimposed on the lane 22 in the real landscape, for example, when its own vehicle reaches a position of 50 m before the intersection. The information image 50a projected onto the windshield 104 is distorted by the reflective mirror 14 of a curved surface shape and the curved windshield 104 which is arranged in the vehicle display device main body 4. Therefore, the controller 13 corrects the distortion by calculating the distortion of the information image 50a on the basis of the eye point EP detected in Step S2 and distorting before projecting the information image 50a.

In Step S6, the controller 13 causes the shape of the information image 50a displayed superimposed on the real landscape by the image display unit 11 to be changed to a shape based on the shape of the white line in the real landscape chronologically obtained from the position of the white line. Thereafter, when the right, the left turn, or the lane change of its own vehicle is determined to be completed, the controller 13 ends the display of the information image 50a by the image display unit 11, and ends this process. The controller 13 may be configured to finely adjust the position of the information image. 50a in accordance with the change in the position of the eye point EP detected in Step S2.

As described above, the vehicle display device 1 according to the first embodiment includes the vehicle front side camera 2 that acquires a plurality of front area images 20, the image analyzing unit 12 that detects the position of the white line 21a (or the white line 21b) in each front area image 20, and the controller 13 that acquires the information image 50. The controller 13 causes the information image 50 to be displayed superimposed on the real landscape in the shape based on the shape of the white line 21a (or the white line 21b) in the real landscape obtained from the position of the white line 21a (or the white line 21b). The controller 13 causes the shape of the information image 50 to be changed to the shape based on the change in the shape of the white line 21a (or the white line 21b) in the real landscape chronologically obtained from the position of the white line 21a (or the white line 21b).

According to the vehicle display device 1 and the display control method of the first embodiment, the information image 50a can be displayed on the road at which the driver D is constantly looking. For example, it is unnecessary for the driver D to search for the information image 50a displayed on the windshield 104, and it is possible to improve the convenience and the safety. Further, since the information image 50a has the shape based on the shape of the white line in the real landscape, it is possible to display natural information on the road. Further, the shape of the information image 50a can be changed in accordance with the temporal change in the shape of the white line in the real landscape.

Further, in the vehicle display device 1 according to the first embodiment, in a case in which the arrow image 51 in the information image 50 is determined to be the lane change to the left turn of its own vehicle or the lane change to the left side, the controller 13 causes the information image 50a to be displayed along the position of the position of the left white line 21a in the real landscape in the shape based on the shape of the left white line 21a sandwiching the lane 22 out of a pair of white lines 21a and 21b. In a case in which the arrow image 51 is the right turn of its own vehicle or the lane change to the right side, the controller 13 causes the information image 50a to be displayed along the position of the right white line 21b in the real landscape in the shape based on the shape of the right white line 21b sandwiching the lane 22 out of a pair of white lines 21a and 21b. Accordingly, it is possible to display the information image 50a along the position of the corresponding white line in the shape based on the shape of one of the white lines 21a and 21b in accordance with the right or left turn or the lane change destination indicated by the arrow image 51, and it is possible to display more natural information.

In the first embodiment, the controller 13 may calculate the distortion of the information image 50a on the basis of the detected eye point EP and correct the shape of the information image 50a. or may finely correct the position of the information image 50a in accordance with the change in the position of the eve point EP or may not correct the information image 50a based on the eve point EP including it.

In the first embodiment, the image analyzing unit 12 detects a pair of white lines 21a and 21b but may detect one of the white lines 21a and 21b. Further, in a case in which the position of one of the white lines 21a and 21b is unable to be detected, the image analyzing unit 12 may specify the lane 22 using the position of the white line 21a or the white line 21b which is detected immediately before. Alternatively, the distance (lane width) in the width direction (X axis direction) between one white line and the other white line may be specified as, for example, 3 m, and in a case in which the position of one whit line is unable to be detected, the lane 22 may be specified by using the lane width. Here, the lane width is set to 3 m, but the present embodiment is not limited thereto, and the lane width may differ in accordance with a type of road (for example, a general national highway, an automobile expressway, or the like).

In the first embodiment, the coordinates of the white lines 21a and 21b are located at the center of the respective whitelines 21a and 21b in the width direction (X axis direction) as illustrated in FIGS. 4, 5A, and 5B, but the present embodiment is not limited thereto as long as they are the positions capable of specifying the positions of the white lines 21a and 21b.

Further, in the first embodiment, the image display unit 11 may be configured to independently execute the process executed by the controller 13. For example, the image display unit 11 may be configured to display the information image 50 superimposed on the real landscape in the shape based on the shape of the white line in the real landscape obtained from the position of the white line and cause the shape of the information image 50 to be changed to the shape based on the change in the shape of the white line in the real landscape chronologically obtained from the position of the white line.

In the first embodiment, the information images 50 and 50a include the arrow images 51 and 51a and the distance images 52 and 52a, but the information images 50 and 50a are not limited thereto and may include a plurality of pieces of information images such as a vehicle speed and traffic information. The arrow images 51 and 51a are the images indicating the right or left turn or the lane change destination, but an image indicating going straight forward may be included. In other words, in a case in which the route guidance indicates going straight forward, the information image 50 indicating going straight forward is displayed. In a case in which the arrow image 51 indicates a straight line, it is preferable the arrow image 51 to the arrow image 51a in accordance with, for example, the shape (for example, a trapezoid) of the area formed by a pair of white lines 21a and 21b, the preceding vehicle 30, and its own vehicle.

In the first embodiment, the controller 13 causes the information image 50 to be displayed superimposed on the real landscape by the image display unit 11, but it is preferable to arrange the information image 50 at a position not overlapping the road sign on the lane 22 in the real landscape.

In the first embodiment, the image analyzing unit 12 detects the white line extending from its own vehicle side to the area side in front of the vehicle in each front area image 20, but the present embodiment is not limited thereto, and if it is a road sign, it may be a yellow line, and it may be a yellow line, or a combination of a white line and a yellow line. The white line and the yellow line may be solid lines, broken lines, or a combination thereof.

In the first embodiment, the vehicle front side camera 2 and the driver camera 3 are connected to the vehicle display device main body 4 via the communication lines 15 and 16 in a wired manner, respectively, but they may be wirelessly connected. Accordingly, or the communication lines 15 and 16 and a wiring work are unnecessary, and it is also possible to improve the restriction to the layout of the vehicle front side camera 2 and the driver camera 3.

Further, in the first embodiment, the controller 13 acquires the information image 50 from the navigation device 5, but the present embodiment is not limited thereto. For example, the controller 13 may be configured to acquire the route guidance information or the like from the outside through wireless communication.

In the first embodiment, the route guidance information has been described as an example of the information to be informed to the driver D, but the information to be informed to the driver D may be information for supporting the driving of the driver D. For example, the information to be informed to the driver D may be vehicle speed information, vehicle state information, road information, external environment information, passenger information, or the like.

### Second Embodiment

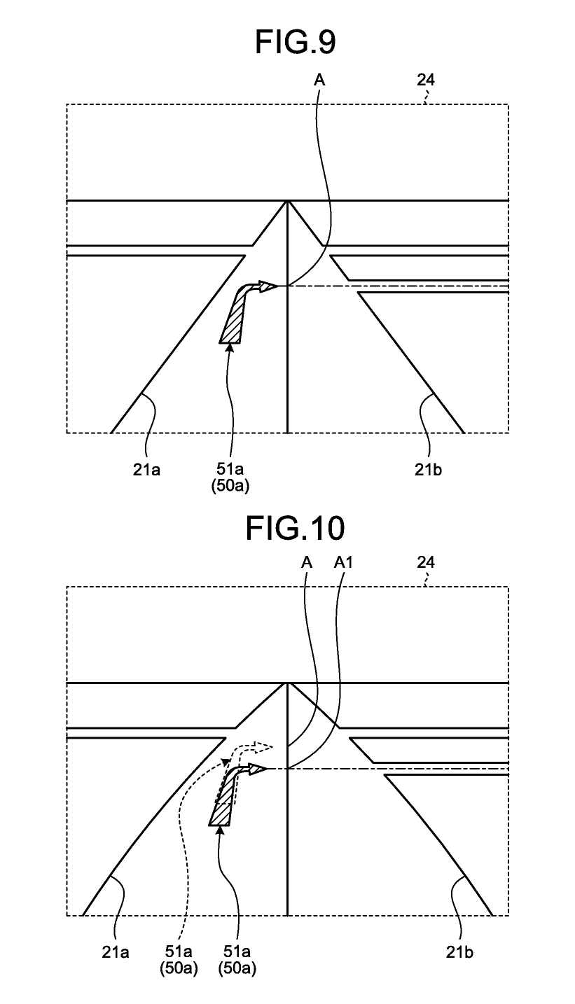

Next, a vehicle display device and a display control method according to a second embodiment of the present invention will be described with reference to FIGS. 9 and 10. FIG. 9 is a diagram illustrating an example of an information image according to the second embodiment. FIG. 10 is a diagram illustrating another example of a display image according to the second embodiment. FIG. 9 illustrates an example of an information image which is projected onto the display range 24 on the windshield 104 and superimposed on a real landscape including a flat road. FIG. 10 illustrates an example of an information image which is projected onto the display range 24 on the windshield 104 and superimposed on a real landscapes including a road having a descending slope.

The vehicle display device 1 according to the second embodiment differs from the first embodiment in that the display position of the information image 50a is corrected in accordance with the road shape. In the following description, the same reference numerals are given to components common to those of the first embodiment, and description thereof will be omitted (the same applies to third and fourth embodiments).

The controller 13 in the present embodiment acquires an intersection position in front of its own vehicle and a current position of its own vehicle from the navigation device 5 and corrects a display position of the information image 50a on the basis of the road shape obtained from the shape of a pair of white lines 21a and 21b. The intersection position in front of its own vehicle is, for example, an intersection position at this a left turn or a left turn is performed in front of its own vehicle in the route to the destination. The information image 30a has a shape based on the shape of the white line in the real landscape obtained from the position of the white line 21b, for example, by the above-described method. The controller 13 specifies a coordinate position corresponding to the intersection position in front of its own vehicle in the display range 24 on the windshield 104. The controller 13 recognizes the road shape from the shape of a pair of white lines 21a and 21b and determines the presence or absence of a slope. In a case in which it is determined that there is a slope, the controller 13 corrects the specified coordinate position. In a case in which the position of its own vehicle approaches the intersection in front of its own vehicle, the controller 13 causes the information image 50a to be displayed at the corrected coordinate position by the image display unit 11.

The vehicle display device 1 according to the second embodiment acquires the intersection position in front of its own vehicle and the current position of its own vehicle and corrects the display position of the information image 50a on the basis of the road shape obtained from the shape of a pair of white lines 21a and 21b. Accordingly, it is possible to display the information image 50a to be superimposed on the real landscape at the intersection position in front of its own vehicle in the real landscape regardless of the road shape and to improve the quality of the vehicle display device 1. In the conventional vehicle display device, regardless of whether it is a flat road or a sloped road, the display position of the information image 50a is decided in the same way. On the flat road, for example, although the information image 50a is displayed at the display position obtained by the conventional method as illustrated in FIG. 9, it is possible to perform display to indicate the intersection position A of its own vehicle in the real landscape. However, on the inclined road, for example, if the information image 50a is displayed at the display position obtained by the conventional method as illustrated in FIG. 10, the information image 50a is displayed at the position indicated by the broken line, and positional deviation is likely to occur for an intersection position A1 of its own vehicle in the real landscape. In this regard, the display position of the information image 50a is corrected in accordance with the presence or absence of the slope of the road shape, and thus the information image 50a can indicate an appropriate intersection position in the real landscape.

In the second embodiment, the road shape is estimated from the shape of a pair of white lines 21a and 21b, but the present embodiment is not limited thereto, and for example, the road shape may be estimated by considering an angle of view and a perspective of the front area image 20.

### Third Embodiment

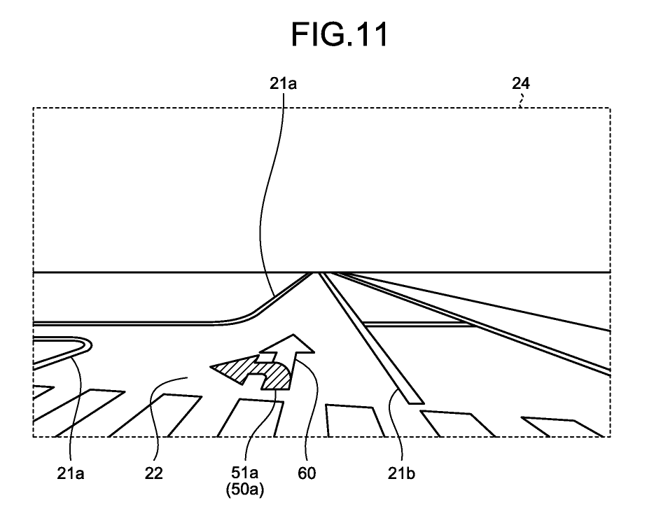

Next, a vehicle display device and a display control method according to a third embodiment of the present invention will be described with reference to FIG. 11. FIG. 11 is a diagram illustrating an example of an information image according to the third embodiment. FIG. 11 illustrates an example of an information image which is projected onto the display range 24 on the windshield 104 and superimposed on the real landscape.

The vehicle display device 1 according to the third embodiment differs from the first embodiment in that the information image 50a is superimposed on a road sign in the real landscape.

The image analyzing unit 12 in the present embodiment detects the road sign on the lane 22 extending from each front area image 20 to the area in front of the vehicle. For example, the image analyzing unit 12 detects a road sign 60 as illustrated in FIG. 11. The controller 13 causes the information image 50 to be displayed superimposed on the real landscape in the shape based on the shape of the road sign in the real landscape obtained from the detected road sign. For example, the controller 13 changes the shape of the arrow image 51 in the information image 50 to a shape (for example, the arrow image 51a) based on the shape of the road sign 60 in the real landscape obtained from the road sign 60, and causes the arrow image 51 to be displayed superimposed on the road sign 60 in the real landscape by the image display unit 11. In a case in which the arrow image 51a is display superimposed on the road sign 60 in the real landscape, in order to cause the driver D to distinguish and recognize the arrow image 51a and the road sign 60, a display color of the information image 50a including the arrow image 51a is displayed in a color different from a color of the road sign 60. For example, the information image 30a in the present embodiment has the shape based on the shape of the road sign 60 in the real landscape obtained from the shape of the road sign 60. The controller 13 causes the shape of the arrow image 51a to be changed to a shape based on a change in the shape of the road sign 60 in the real landscape in accordance with a chronological change of the road sign 60.

In the vehicle display device 1 according to the third embodiment, the image analyzing unit 12 detects the road sign 60 on the lane 22 extending from its own vehicle side to the front area in each front area image. The controller 13 causes the information image 50 to be displayed superimposed on the real landscape in a shape based on the shape of the road sign 60 in the real landscape obtained from the road sign 60. The controller 13 causes the shape of the information image 50a to be changed to a shape based on a change in the shape of the road sign 60 in the real landscape chronologically obtained from the road sign 60. Accordingly, for example, it is possible to display turn by turn to be superimposed on road sign 60 and prevent the driver D from overlooking the road sign 60.

In the third embodiment, the information image 50a including the arrow image 51a is displayed in a color different from the color of the road sign 60 in the real landscape, but the present embodiment is not limited thereto, and the information image 50 may be displayed in a blinking manner.

### Fourth Embodiment

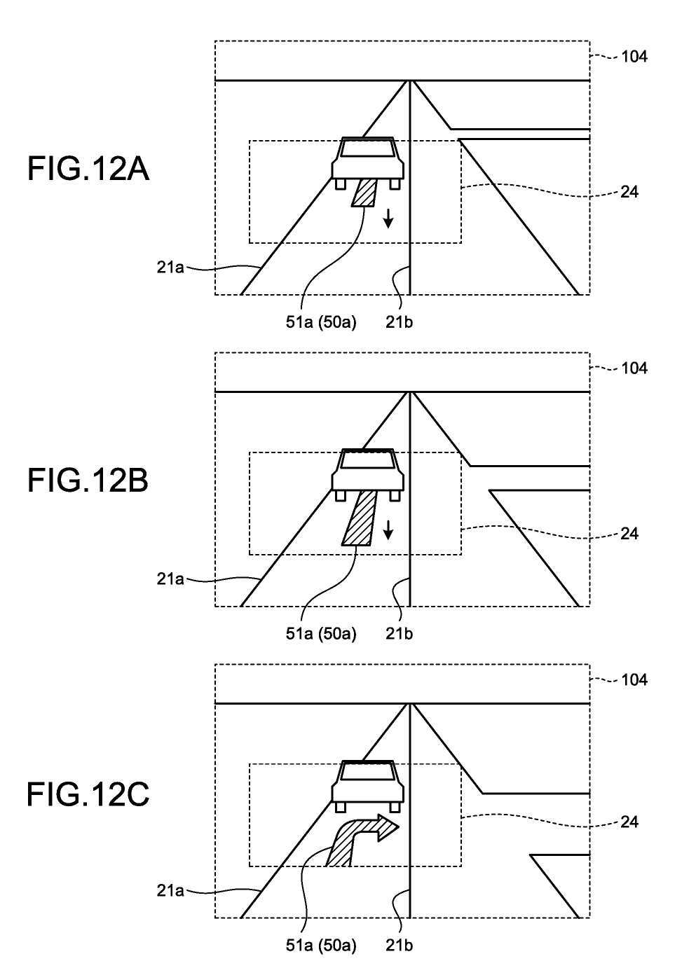

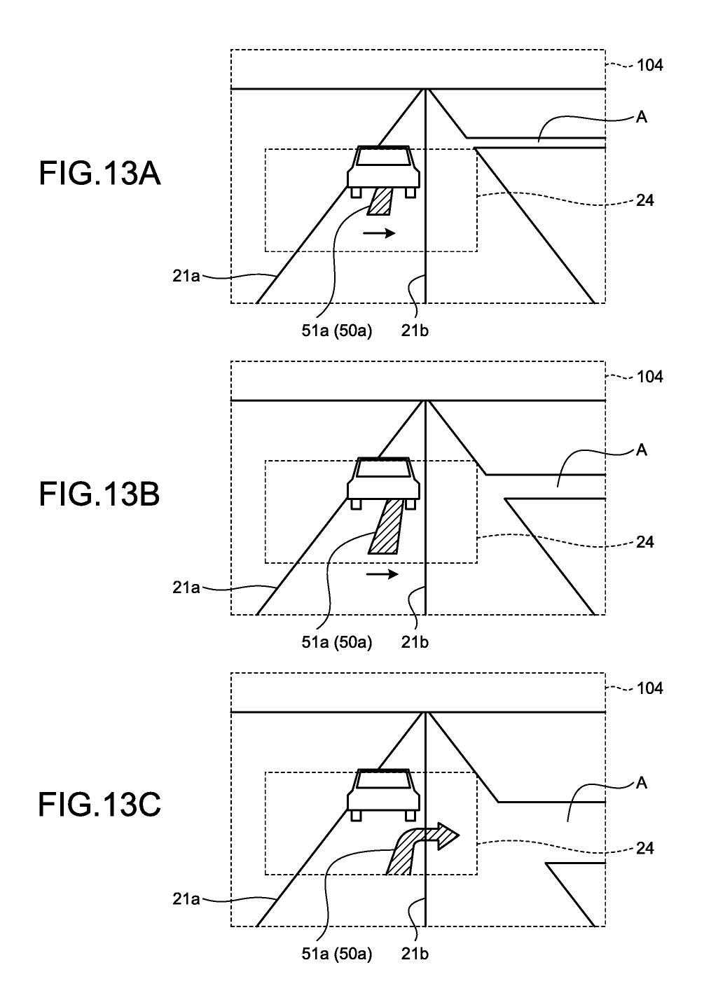

Next, a vehicle display device and a display control method according to a fourth embodiment of the present invention will be described with reference to FIGS. 12A to 12C and FIGS. 13A to 13C. FIGS. 12A to 12C are diagrams for describing a change in an information image according to the fourth embodiment. FIGS. 13A to 13C are diagrams for describing a change in an information image according to the fourth embodiment.

The vehicle display device 1 according to the fourth embodiment differs from the first embodiment in that the information image 50a is scrolled in the display range 24 on the windshield 104 in a manner similar to movement of the road sign in the real landscape.

The controller 13 in the present embodiment acquires the intersection position in front of its own vehicle and the current position of its own vehicle from the navigation device 5 and causes the information image 50a to be scrolled in the display range 24 on the windshield 104 in a manner similar to the movement of the road sign in the real landscape. Here, the intersection position in front of its own vehicle is, for example, an intersection position A at which a right turn or a left turn is performed in front of its own vehicle in the route to the destination. The information image 50a has a shape based on the shape of the white line in the real landscape obtained from the position of the white line 21b, for example, by the above-described method. For example, the display range 24 is a specification in which the entire information image 50a is unable to be displayed. The controller 13 specifies the coordinate position corresponding to the intersection position in front of its own vehicle in the real landscape in the display range 24. As illustrated in FIG. 12A, the controller 13 causes at least a part of the arrow image 51a in the information image 50a in the real landscape to be displayed at the coordinate position specified by the display range 24. As illustrated in FIGS. 12B and 12C, as the position of its own vehicle approaches the intersection in front of its own vehicle, the controller 13 causes the arrow image 51a to be scrolled within the display range 24 in the real landscape.

The vehicle display device 1 according to the fourth embodiment acquires the intersection position in front of its own vehicle and the current position of its own vehicle and performs the scrolling in the display range 24 on the windshield 104 in a manner similar to the movement of the road sign in the real landscape. Accordingly, even in a case in which the display range of the turn-by turn is narrow, and the entire information image 50a is unable to be displayed, it is possible to cause the driver D to recognize the information image 30a by displaying the information image 50a while scrolling the information image 50a in the display range 24. Further, it is possible to cause the driver D to recognize the information image 50a similarly to the road sign in the real landscape, and it is possible to display natural information in accordance with the change in the real landscape.

In the fourth embodiment, the controller 13 causes the arrow image 51a in the information image 50a to be scrolled an up-and-down direction of the display range 24, but the present embodiment is not limited thereto. For example, as illustrated in FIGS. 13A to 13C, the controller 13 may be configured to cause scrolling to be performed in a right direction or a left direction within the display range 24 in accordance with scrolling in a vertical direction. In this case, it is preferable that the scroll direction in the left-right direction be decided in accordance with the direction indicated by the arrow image 51a.

According to the vehicle display device and the display control method according to the present embodiments, there is the effect in that the information to be informed to the driver is displayed on the road at which the driver is constantly looking.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device that projects a display image in front of a driver of a vehicle and causes the display image to be displayed superimposed on a real landscape in front of the vehicle, the vehicle display device comprising:
a front area image acquiring unit that acquires a plurality of front area images by sequentially capturing the real landscape in front of the vehicle chronologically;
a colored line detecting unit that detects a position of at least one colored line extending from an own vehicle side to an area in front of the vehicle in each of the front area images; and
a controller that acquires an information image to be informed to the driver, wherein
the controller causes the information image to be displayed superimposed on the real landscape in a shape based on a shape of the colored line in the real landscape obtained from a position of the colored line, and
causes a shape of the information image to be changed to a shape based on a change in the shape of the colored line in the real landscape chronologically obtained from the position of the colored line.

2. The vehicle display device according to claim 1, wherein
the information image includes an image relating to route guidance of the vehicle.

3. The vehicle display device according to claim 1, wherein
the colored line detecting unit detects positions of a pair of colored lines sandwiching a lane extending from its own vehicle side to the area in front of the vehicle,
in a case in which an image relating to route guidance of the vehicle in the information image to be displayed is a left turn or a lane change to a left side of the own vehicle, the controller causes the information image to be displayed along a position of a left side colored line in the real landscape in a shape based on. a shape of the left side colored line sandwiching the lane out of the pair of colored lines, and
in a case in which the image relating to the route guidance of the vehicle in the information image to be displayed is a right turn or a lane change to a right side of the own vehicle, the controller causes the information image to be displayed along a position of a right side colored line in the real landscape in a shape based on a shape of the right side colored line sandwiching the lane out of the pair of colored lines.

4. The vehicle display device according to claim. 2, wherein
the colored line detecting unit detects positions of a pair of colored lines sandwiching a lane extending from its own vehicle side to the area in front of the vehicle,
in a case in which an image relating to route guidance of the vehicle in the information image to be displayed is a left turn or a lane change to a left side of the own vehicle, the controller causes the information image to be displayed along a position of a left side colored line in the real landscape in a shape based on a shape of the left side colored line sandwiching the lane out of the pair of colored lines, and
in a case in which the image relating to the route guidance of the vehicle in the information image to be displayed is a right turn or a lane change to a right side of the own vehicle, the controller causes the information image to be displayed along a position of a right side colored line in the real landscape in a shape based on a shape of the right side colored line sandwiching the lane out of the pair of colored lines.

5. A display control method of a vehicle display device that projects a display image in front of a driver of a vehicle and causes the display image to be displayed superimposed on a real landscape in front of the vehicle, the display control method comprising:
a front area image acquisition step of acquiring a plurality of front area images by sequentially capturing the real landscape in front of the vehicle chronologically;
a colored line detection step of detecting a position of at least one colored line extending from an own vehicle side to an area in front of the vehicle in each of the front area images;
an image display step of causing an information image to be informed to the driver to be displayed superimposed on the real landscape in a shape based on a shape of the colored line in the real landscape obtained from a position of the colored line; and
a control step of causing a shape of the information image to be changed to a shape based on a change in the shape of the colored line in the real landscape chronologically obtained from the position of the colored line.
